(19) United States
(12) Patent Application Publication
(10) Pub. No.: US 2025/0001475 A1
(43) Pub. Date: Jan. 2, 2025

(54) EXTRACTION OF ORGANICS FROM WASTE MATERIAL

(71) Applicant: ANAERGIA INC., Burlington (CA)

(72) Inventors: Sasha ROLLINGS-SCATTERGOOD, Burlington (CA); Andrew BENEDEK, Burlington (CA); Juan JOSSE, Burlington (CA); Ashwani KUMAR, Burlington (CA)

(21) Appl. No.: 18/576,460

(22) PCT Filed: Jul. 12, 2022
(86) PCT No.: PCT/CA2022/051086

§ 371 Date: Jan. 4, 2024

Related U.S. Application Data
(60) Provisional application No. 63/203,178, filed on Jul. 12, 2021.

(51) Int. Cl. B09B 3/80; B02C 23/08; B09B 101/25; B09B 101/50; B09B 101/70; B09B 101/75; B09B 101/85; B30B 9/06

(52) U.S. Cl. CPC B09B 3/80; B02C 23/08; B09B 2101/25; B09B 2101/50; B09B 2101/70; B09B 2101/75; B09B 2101/85; B30B 9/067

(57) ABSTRACT

The present description relates to press extractors for processing municipal solid waste or source separated organics, and can have large perforations for separation of a wet fraction from a liquid depleted fraction. The extractor can also be operated based on a target plug thickness of the liquid-depleted plug left over in the perforated chamber after compression. The extractors can facilitate good organics extraction yields, and lower operating pressures, among other benefits.

### TECHNICAL FIELD

The technical field generally relates to extraction of a wet fraction from a multiphase waste material, and more particularly to extractor systems and processes for extracting a wet fraction that includes organics from waste materials, such as municipal solid waste (MSW) and source separated organics (SSO), using a press-type extractor.

### BACKGROUND

Extracting organics from MSW and SSO is becoming more common due to stricter regulations on the landfilling of organics and the economics of resource recovery, such as converting organic waste into energy, fertilizer and clean water. Press extractors have been used to compress MSW and SSO to promote separation of the wet organics-rich materials from the solid, undesirable materials such as glass, rocks, metal, and plastics. There are various challenges related to such press extractors, such as providing high yields of organics and high throughput while minimizing undesirable material in the wet fraction. There is a need for technologies that respond to at least some of the challenges that currently exist.

### SUMMARY

In the context of the present application, in some implementations there is provided an extraction system for processing waste material to form a wet fraction comprising organics and a liquid-depleted fraction, comprising: a barrel; a plunger received within the barrel and configured to displace axially within the barrel; and a perforated chamber having perforations and being connected to a distal end of the barrel, the perforated chamber being configured to receive a load of waste material and a head of the plunger during axial displacement into the perforated chamber to compress the load of waste material to cause wet material to be expelled out of the perforated chamber through the perforations and form the wet fraction, the perforations being sized and configured to have a diameter between 20 mm and 40 mm and to provide a total open area between 10% and 40%.

In some implementations, there is provided an extraction process for treating waste material to form a wet fraction comprising organics and a liquid-depleted fraction, comprising: providing a load of the waste material in a perforated chamber comprising perforations; pressing the load of the waste material within the perforated chamber with a plunger to cause wet material to flow out of the perforated chamber through the perforations and form the wet fraction and a liquid-depleted plug, the perforations being sized and configured to have a diameter between 20 mm and 40 mm and to provide a total open area between 10% and 40%; and removing the plug from the perforated chamber.

In some implementations, there is provided an extraction system for processing waste material to form a wet fraction comprising organics and a liquid-depleted fraction, comprising: a barrel; a plunger received within the barrel and configured to displace axially within the barrel; a perforated chamber having perforations and being connected to a distal end of the barrel, the perforated chamber being configured to receive a load of waste material and a head of the plunger during axial displacement into the perforated chamber to compress the load of waste material to cause wet material to be expelled out of the perforated chamber through the perforations and form the wet fraction; wherein the load of the waste material comprises cellulosic materials, organic-rich liquid materials, and non-organic materials; and wherein the perforations are sized and configured such that at a compression pressure between 60 and 160 bar, the wet fraction and/or liquid-depleted fraction have one or more of the following characteristics: the wet fraction has at least 10 wt %, 15 wt %, or 20 wt % paper; the wet fraction has a paper percentage greater than a paper percentage of the waste material; the wet fraction is composed of at least 5 wt %, 10 wt % or 15 wt % of cellulose-plastic components; the wet fraction has a plastic content between 6 wt % and 10 wt %; the wet fraction has a plastics percentage that is between a quarter and a half of the plastics percentage in the waste material; the wet fraction has an organics yield of at least 70%, at least 80% or at least 90%; the liquid-depleted fraction has at most 15 wt %, 10 wt %, or 5 wt % of the cellulosic materials; the liquid-depleted fraction has a percentage of the cellulosic materials that is lower than the cellulosic materials percentage of the waste material; and/or the liquid-depleted fraction has an organics content below 20 wt %, below 15 wt %, or below 10 wt %.

In some implementations, there is provided an extraction process for treating waste material to form a wet fraction comprising organics and a liquid-depleted fraction, comprising: providing a load of the waste material in a perforated chamber comprising perforations, the load of waste material comprising cellulosic materials, organic-rich liquid materials, and non-organic materials; pressing the load of the waste material within the perforated chamber with a plunger to cause wet material to flow out of the perforated chamber through the perforations and form the wet fraction and a liquid-depleted plug, the perforations being sized and configured to have a diameter and total open area such that the wet fraction and/or liquid-depleted plug have one or more of the following characteristics: the wet fraction has at least 10 wt %, 15 wt %, or 20 wt % paper; the wet fraction has a paper percentage greater than a paper percentage of the waste material; the wet fraction is composed of at least 5 wt %, 10 wt % or 15 wt % of cellulose-plastic components; the wet fraction has a plastic content between 6 wt % and 10 wt %; the wet fraction has a plastics percentage that is between a quarter and a half of the plastics percentage in the waste material; the wet fraction has an organics yield of at least 70%, at least 80% or at least 90%; the liquid-depleted plug has at most 15 wt %, 10 wt %, or 5 wt % of the paper; the liquid-depleted plug has a percentage of paper that is lower than the paper percentage of the waste material; and/or the liquid-depleted plug has an organics content below 20 wt %, below 15 wt %, or below 10 wt %; and removing the plug from the perforated chamber.

In some implementations, there is provided an extraction system for processing waste material to form a wet fraction comprising organics and a liquid-depleted fraction, comprising: a barrel; a plunger received within the barrel and configured to displace axially within the barrel a perforated chamber having perforations and being connected to a distal end of the barrel and configured to receive a load of waste material and to receive a head of the plunger during axial displacement into the perforated chamber to compress the load of waste material to cause wet material to flow out of the perforated chamber through the perforations and form the wet fraction and a liquid-depleted plug; and a control assembly configured to measure a position of the plunger to determine a measured plug thickness of the liquid-depleted plug, and control compression of the load of the waste material at least in part based on a target plug thickness of the liquid-depleted plug within the perforated chamber.

In some implementations, there is provided an extraction process for treating waste material to form a wet fraction comprising organics and a liquid-depleted fraction, comprising: providing a load of the waste material in a perforated chamber comprising perforations; pressing the load of the waste material within the perforated chamber with a plunger to cause wet material to flow out of the perforated chamber through the perforations and form the wet fraction and a liquid-depleted plug; controlling compression of the load based on a target plug thickness of the liquid-depleted plug; and removing the plug from the perforated chamber.

### BRIEF DESCRIPTION OF THE DRAWINGS

FIGS. 1A to 1D are side cut view schematics of part of an organics extractor in different positions where a plunger presses waste material to form a plug and obtain a wet fraction.

FIG. 2 is a side cut view schematic of part of an example organics extractor showing a plug of waste material that has an axial plug thickness (PT_{AX}).

FIG. 3 is a side cut view schematic of part of another example organics extractor showing a plug of waste material that has a radial plug thickness (PT_{RAD}).

FIG. 4 is a side cut view schematic of part of a perforated chamber and plunger that can be used for an organics extractor.

FIG. 5 is a side cut view schematic of another example of part of a perforated chamber and plunger that can be used for an organics extractor.

FIGS. 6A to 6D are top cut view schematics of part of an organics extractor comprising two plungers in different positions, where one of the plungers compresses the waste material while also forming a wall of the extractor and the other plunger presses waste material to form a plug and obtain a wet fraction.

FIGS. 7 to 9 are process flow diagrams for extracting a wet fraction from waste material where a target plug thickness is employed for the extraction process.

FIGS. 10A to 10C are schematics of part of an organics extractor comprising a pre-press, a radial ram and an axial plunger in different positions, where the plunger presses waste material to form a plug and obtain a wet fraction.

FIG. 11 is a side cut view of part of a perforated chamber and matrix of an example press extractor.

FIGS. 12A and 12B are schematics showing example perforation patterns.

FIG. 13 is a graph of the feed volume versus plug thickness.

### DETAILED DESCRIPTION

Techniques described herein relate to systems and processes that enhance performance of press extraction of waste materials, such as MSW and SSO, to obtain a wet fraction and a liquid-depleted fraction. When MSW or SSO are processed, the wet fraction is rich in organics and can be converted to biogas, while the liquid-depleted fraction is enriched in solid and non-organic materials. The techniques described herein can include various aspects, such as enlarged perforations for passage of the wet fraction and operating based on plug thickness of the leftover plug of the liquid-depleted material.

For example, the press extraction can be conducted in a press extractor that has relatively large perforations and is designed and/or operated based on plug thickness. The press extractor includes a perforated chamber and a plunger that strokes into the perforated chamber to compress the waste material and thus promote discharge of wet material through perforations while retaining dry material in the form of a compressed plug. In addition, the press extractor can include perforated sections that form the perforated chamber and allow passage of the wet material while retaining the plug of waste material, where the perforations are sized between 20 mm and 40 mm, between 22 mm and 35 mm, or between 25 mm and 30 mm, for example, which is larger than in conventional press extractors. Various other perforation characteristics can be provided in the perforated chamber, as will be discussed in further detail below. The perforated sections with enlarged perforations can be on side walls, a back section and/or a front section of the perforated chamber, where the front section can be defined by the head of the plunger. The press extractor can also be designed and operated based on plug thickness, which can be predetermined as used in process control, and can also be relatively small, such as between 40 mm to 200 mm, 40 mm to 100 mm, or 60 mm to 80 mm and/or which can be about 5% to about 20% of the infeed waste material thickness prior to compression. As will be described in more detail further below, the press extractor can have various configurations to which the techniques described herein can be applied. System and equipment implementations

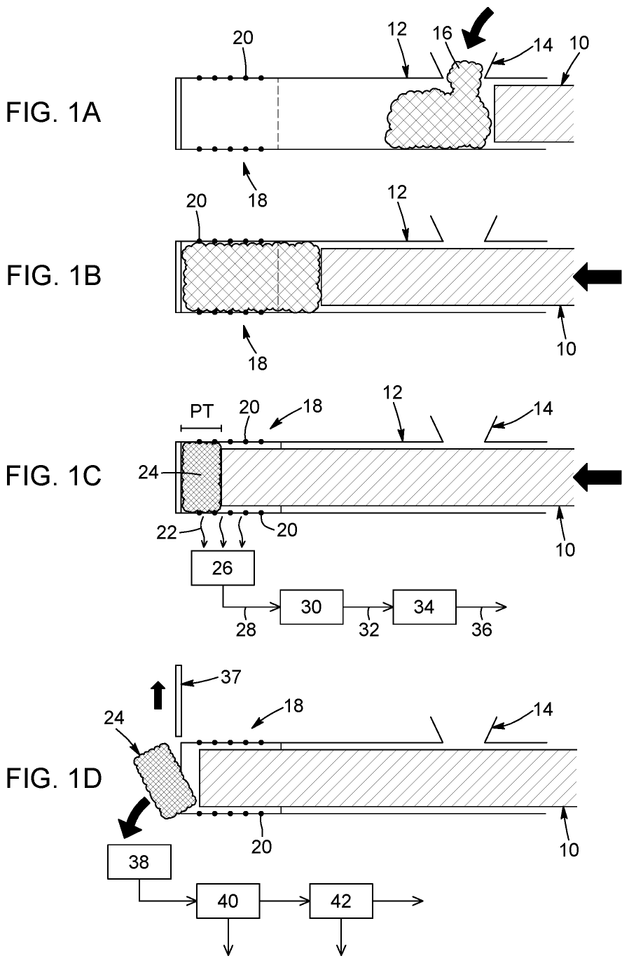

Referring to FIGS. 1A to 1D, the press extractor can include a plunger 10 operatively mounted within a barrel 12 which includes an inlet 14 that is configured to receive a feed 16 of the waste material. FIG. 1A shows the feed 16 entering a section of the barrel 12 with the plunger 10 in a retracted position. Once a load of the waste material has been fed into the barrel 12, the plunger 10 is driven axially along the barrel 12 to displace and press the load of waste material within a perforated chamber 18, as shown in FIGS. 1B and 1C. The perforated chamber 18 includes perforations 20 that allow passage of wet material 22 and formation of a plug 24 within the perforated chamber 18. The wet material 22 can be collected in a collection vessel 26 and forms a wet fraction 28, as shown in FIG. 1C. This wet fraction 28 can be subjected to further processing, such as pre-treatment 30 to remove residual undesirable materials and/or separate the wet fraction into sub-components, to produce a liquor or slurry 32 that is subjected to anaerobic digestion 34 to produce biogas 36.

Still referring to FIGS. 1A to 1D, the plunger 10 is operated to compress the load of waste material to form the plug 24 to have or approach a target plug thickness (PT) defined in this example by the axial distance between a head of the plunger 10 and an end section of the perforated chamber 18. As will be described further below, the PT can be defined axially or radially between the plunger and the perforated chamber depending on the configuration of the press extractor. The compression process is therefore operated based at least in part on a target PT. The press extractor can be controlled so that compression is performed until a target PT is achieved for each run; or the press extractor can be controlled so that the compression achieves a target pressure, a PT is measured, and then the feed quantity is adapted for the following run based on the measured PT and target PT. For each compression run, the plunger can be held in that position for a holding time while wet material continues to pass through the perforations 22. Turning to FIG. 1D, the plug 24 is removed by opening a part of the perforated chamber 18, e.g., by displacing a back end section 37 as illustrated, and optionally pushing and cutting the trailing end of the plug. The plug 24 can then be collected in a plug collection vessel 38 and the plugs can then be subjected to further processing, such as separation stages 40, 42 to recover target materials, if desired. Such separation stages can be adapted depending on the composition of the plug, e.g., magnetic separation to recover metals, plastics recovery methods to recover one or more different types of plastic, screening to separate components of different sizes, and so on. Alternatively, the plug material can be sent for disposal.

The plunger 10 is then retracted through the barrel 12 so that a subsequent load of waste material can be fed into the barrel 12, and the perforated chamber 18 closed, e.g., by closing the back end section 37. Before retraction, the plunger 10 can be used to push the plug 24 out of the perforated chamber 18 and additional components can be used to cut or remove the plug 24 away from the chamber perforated chamber 18. Retraction of the plunger 10 can be controlled to adjust the quantity of feed material that is provided into the barrel: by retracting more or less, the quantity of the load of waste material fed into the barrel for the next run can be greater or lesser, respectively. The plunger retraction can thus be a variable that is controlled based at least in part on the target and measured plug thickness.

It is noted that FIGS. 1A to 1D illustrate schematically an example of certain components of the press extractor, but it should be understood that the press extractor can include various other components and can also take on other configurations. For example, the press extractor can include a frame, a drive mechanism for driving the plunger, as well as various components that aid in the operation of the press extractor. In addition, the press extractor can include multiple plungers that are oriented perpendicularly to each other. The press extractor can also have a radial pre-press assembly that includes a pre-press and a radial ram that radially compress the infeed material prior to an axial plunger performing the main compression. Example press extractors and features that can be used in conjunction with the processes and systems described herein are described in EP 2344284 (Gonella), U.S. Pat. No. 10,589,486 (Oude Grotebevelsborg), EP 1207040 (Gonella), which are incorporated herein by reference.

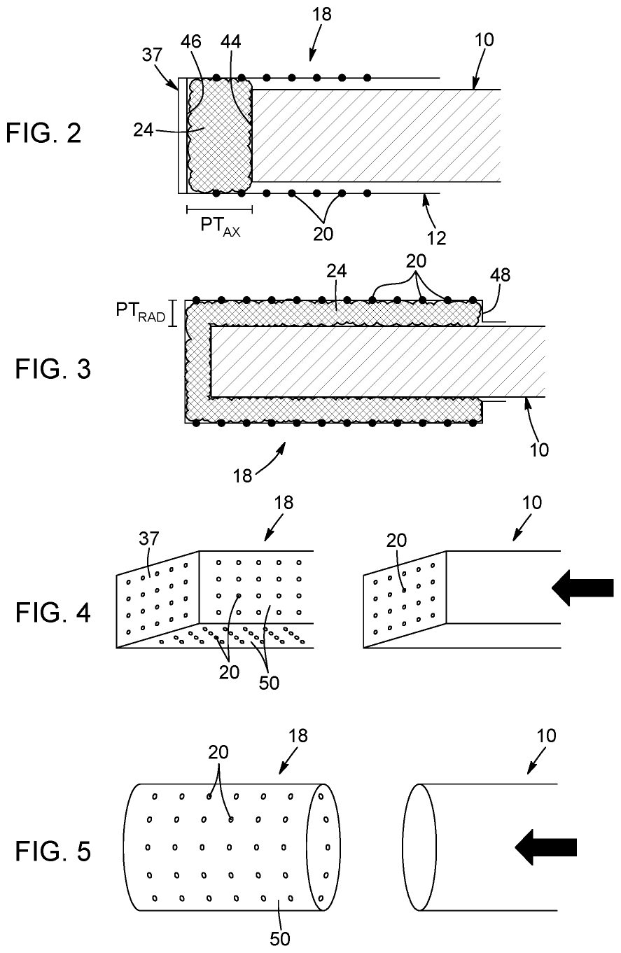

Turning now to FIG. 2, the press extractor can be configured so that there is low tolerance between the outer surface of the plunger 10 and the inner surface of the perforated chamber 18, such that the waste material is axially compressed. In this configuration, the plug thickness can be defined as an axial plug thickness (PT_{AX}). In this regard, the PT_{AX} can be controlled or determined based on the distance between an outer end surface 44 of the plunger 10 and an inner back surface 46 of the perforated chamber 18, particularly when such surfaces are flat and parallel to each other. If one or both of those surfaces 44, 46 are not flat and/or parallel, then the plug thickness can be determined based on an averaging of the distance between the opposed surfaces, for example. For this configuration, the target PT_{AX} can be determined and the press extractor can be operated accordingly so that the plunger 10 stops at the appropriate location. The target plug thickness can be pre-determined prior to operating the press extractor and it can be changed over time depending on various factors, such as the composition of the waste material, downstream processing requirements for the plug or wet fractions, and other factors.

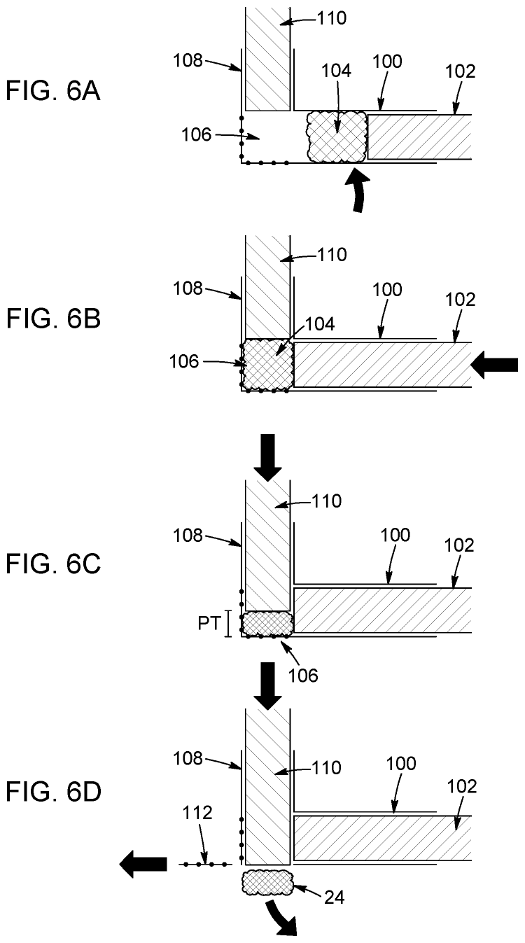

Referring now to FIG. 3, in another example configuration of the press extractor, the plunger 10 and the perforated chamber 18 are sized relative to each other to provide an annular space 48 between them. In this configuration, when the plunger 10 axially enter the perforated chamber 18, the waste material is displaced and compressed substantially into the annular space 48 such that the plug 24 has a tubular-like shape. The plug thickness can thus be defined as a radial plug thickness (PT_{RAD}). For this configuration, the target plug thickness can be determined during the design stage of the press extractor and kept constant during operation. In addition, it is possible to modify the PT_{RAD}, for example by replacing the plunger 10 with one having a different width or diameter and other components so that the plunger 10 can stroke in and out of the perforated chamber 18.

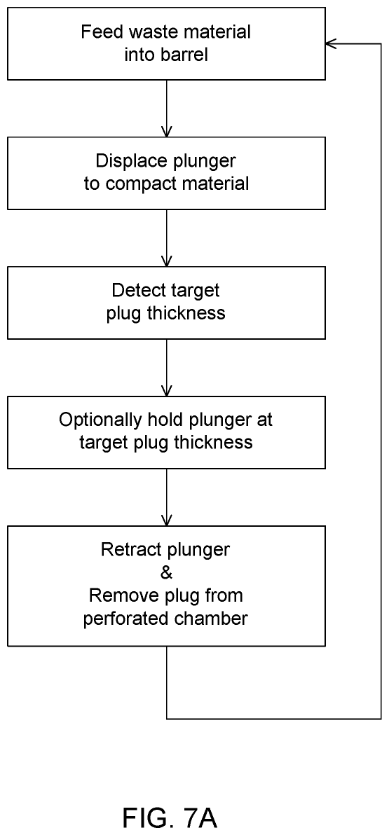

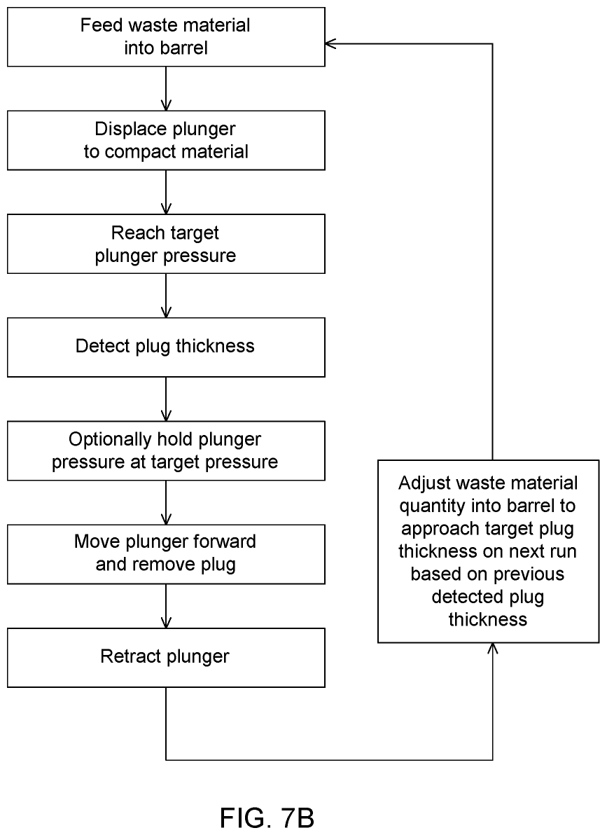

Turning now to FIGS. 4 and 5, the plunger 10 and perforated chamber 18 can have different forms and structures. For instance, the plunger 10 and perforated chamber 18 can have rectangular (e.g., square) cross-sections as shown in FIG. 4, or can have circular cross-sections as shown in FIG. 5. Other cross-sections are also possible. In addition, the plunger 10 can have no perforations as shown in FIG. 5, or can have perforations 20 on certain sections as shown in FIG. 4 as well as internal fluid passages. The perforations and fluid passages on the plunger head allow wet material to pass through to report with the wet fraction, and can thus facilitate higher yields and throughput, for example. Furthermore, the back section 37 of the perforated chamber 18 can include perforations, as shown in FIG. 4, or not. The perforated chamber 18 has side walls 50 that can be flat and plate shaped as in FIG. 4, or curved and cylindrical as in FIG. 5. Other cross-sections are also possible.

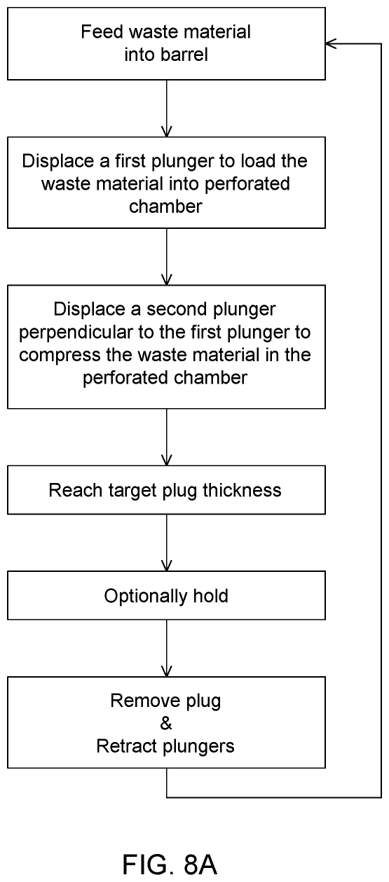

Referring to FIGS. 6A to 6D, the press extractor can include multiple plungers that can be operated to position and compress the waste material. In one implementation, the press extractor includes a loading barrel 100 that houses a first plunger 102 and is configured to receive a load of the waste material 104, as shown in FIG. 6A. The first plunger 102 is then operated to displace the waster material toward a perforated chamber 106 and to define one of the side walls of the chamber, as shown in FIG. 6B. The perforated chamber 106 is also in communication with a second barrel 108 which houses a second plunger 110. Once the waste material is positioned by the first plunger 102 so that the head of the first plunger defines a side of the perforated chamber, the second plunger 110 is driven into the perforated chamber 106 to compress the waste material and form the plug 24, as shown in FIG. 6C. The PT in this instance is shown in FIG. 6C and is in the direction of the pressing of the second plunger 110. It is noted that while the first plunger 102 can provide some initial compression in one direction, the second plunger 110 provides the final compression in a different direction so as to define the PT of the plug 24. After the second plunger reaches a compression position and is optionally held there for a few seconds, a removable end section 112 (shown in FIG. 6D) of the perforated chamber 106 is displaced to allow the plug 24 to be removed, optionally by displacing the second plunger 110, as shown in FIG. 6D. It is noted that the end section 112 can be perforated and can be located opposed to the first or second plunger, such that the corresponding plunger pushes the plug out of the chamber. When the end section 112 is located opposed to the first plunger, the second plunger would be retracted sufficiently to allow the first plunger to push and scrape the plug material out of the chamber. Once the plug is removed from the chamber, the two plungers can be retracted so that a fresh load of waste material can be fed into the loading barrel 100 and another cycle can begin. As discussed above, this type of dual plunger press extractor can have various components and configurations.

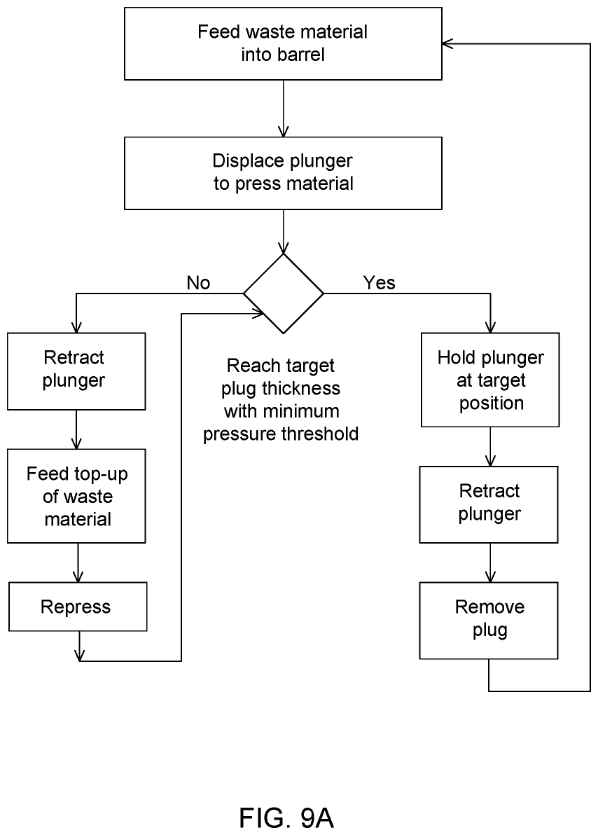

Another optional feature of the press extractor can be a pre-press assembly that can, for example, include a pre-press and a ram that radially enclose the infeed waste material and also, in the closed configuration, form part of the barrel so that a main axial plunger can compress the waste material within a perforated chamber. Referring to FIGS. 10A to 10C, for example, the press extractor can include a frame 200 having a barrel 202 coupled to a feed inlet 204 for receiving waste material 206. At a section of the barrel 202, the extractor also includes a pre-press assembly 208 and a ram 210 that can move from an open configuration (see FIG. 10A) to a closed configuration (see FIGS. 10B and 10C) to pre-press the waste material and form part of the barrel cavity. Once the ram and pre-press assembly are closed, a main axial plunger 212 (see FIG. 10C) can be displaced axially to compress the waste material into a perforated chamber 214. A wet fraction 216 is removed and a plug 24 is formed. A removable section 218 can be slid to the side or otherwise removed to facilitate withdrawal of the plug 24, which can include further displacement of the main plunger 212 to push out the plug 24.

It is also noted that various additional features can be provided for the press extractor. For example, a single extractor can include multiple perforated chambers associated with one or more plungers for compression of material.

Removal of the plug from the perforated chamber can be achieved in various ways, and can depend on the overall construction of the press extractor. The plug can be removed by advancing a plunger that is used to compress the material, a plunger that is used to advance the material into the chamber, or another component that pushes the plug out of the chamber. For example, in some implementations, the plunger that compressed the material to achieve the PT can be retracted, and then another component can be used to push out the plug. For the radial compression extractor, such as the one shown in FIG. 3, the plunger can be retracted and then a removal ram that is sized similar to the internal width of the chamber can be used to push out the plug.

While several possible configurations of the press extractor have been described and illustrated herein, it is noted that other features and configurations are also possible. For instance, the press extractor can have components for feeding waste material, withdrawing waste material, driving and controlling moving parts such as plungers, and providing support and interconnection between the various components. In addition, the press extractor can be configured to not have certain components, such as not having a barrel section that receives waste material such that the waste material is fed directly into the perforated chamber and the plunger can then perform the compression.

In some implementations, the perforations 20 that are present in the side walls of the perforated chamber 18, the back section 37, and/or the head of the plunger 10 are sized and configured to provide enhanced performance in terms of organics yield and/or throughput capacity. For example, the perforations 20 can be sized to have a diameter from 15 mm to 40 mm, from 17 mm to 35 mm, from 20 mm to 30 mm, or from 22 mm to 28 mm, and/or to provide a total open area in one or more perforated regions from 10% to 30%, from 12% to 28%, from 15% to 25%, or from 17% to 23%. In this sense, the perforations are relatively large compared to holes used in conventional equipment which have been in the range of 8 mm. The large perforations can each have a perforation area between about 175 mm² and 1300 mm², between 300 mm² and 800 mm², or between 600 mm² to 800 mm², for example, the perforations 20 can also have a center-to-center spacing of 2 to 3 times the diameter of the perforations, for example. In some implementations, at least 50%, 60%, 70%, 80% or 90% of the perforations through which the wet fraction passes are large having one or more of the size properties mentioned above, with any remaining perforations being sized different (e.g., smaller). In one example implementation, the large perforations 20 are present in the side walls of the perforated chamber 18, the back section 37, and the head of the plunger 10; are circular in shape; each have a diameter between 18 mm and 24 mm or between 20 mm and 22 mm; and the total open area of the perforated regions is approximately 22% to 26%. It is also noted that a given wall of the perforated chamber can include one or more perforated regions, with the other regions being non-perforated and designed for facilitating fastening and assembling the unit together. Most of each wall of the perforated chamber would include perforations, while minor regions would be non-perforated and could include some holes for fasteners.

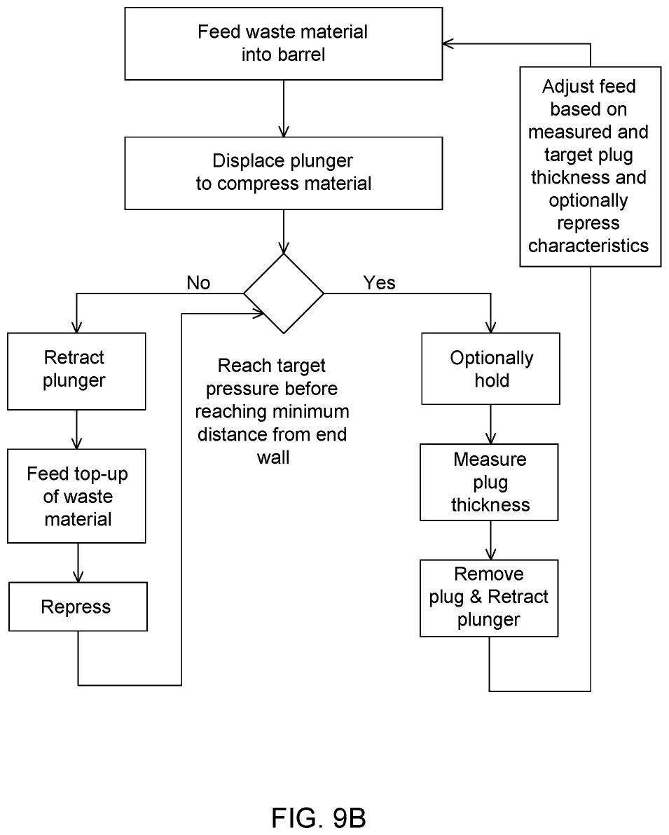

Referring now to FIG. 11, the perforated chamber can include wear plates 300 provided on an inner side, and a matrix 302 provided on an opposed side of the wear plate 300. The wear plate 300 is in direct contact with the waste material and has the perforations 20 described above. The matrix 320 includes channels 306 that communicate with respective perforations 20 to facilitate passage of the wet fraction. The channels 306 can have a diameter (d) that is equal to or larger (e.g., 5% to 25% larger or 10% to 20% larger; or from 1 mm to 5 mm larger) than the diameter (D) of the perforations 20.

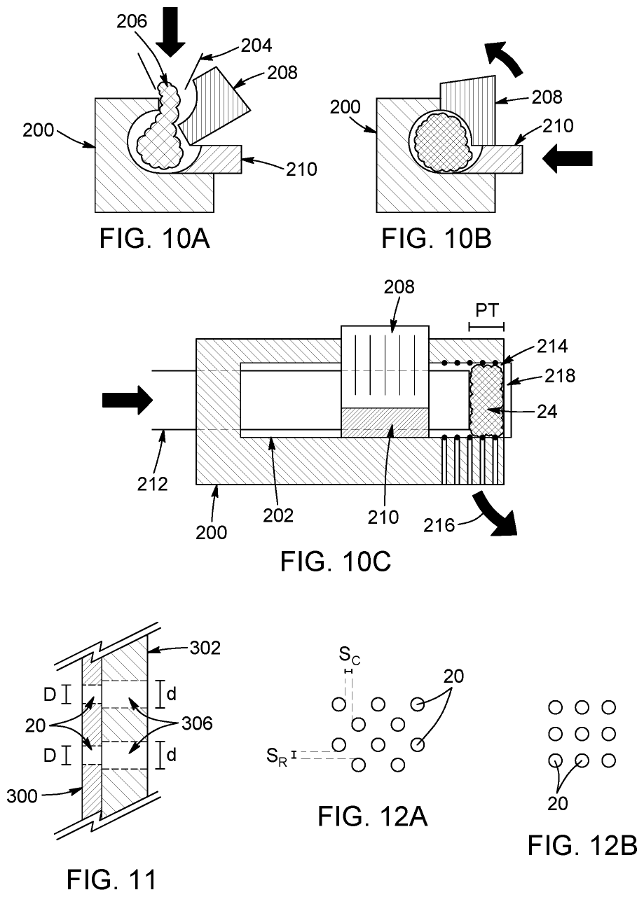

Referring to FIGS. 12A and 12B, the perforations 20 can be arranged in various patterns. For example, the perforations 20 can have an offset pattern as shown in FIG. 12A or an aligned pattern as shown in FIG. 12B, or a combination thereof. The pattern can be regular and repeating or can vary in terms of spacing and arrangement. In some implementations, the pattern is provided as shown in FIG. 12A such that the spacing between each adjacent row of perforations 20 is such that there is no overlap to define an inter-row space (S_{R}) and the spacing between each adjacent column of perforations 20 is such that there is no overlap to define an inter-column space (S_{C}). The S_{C} and S_{R} can be the same or different. It is also noted that various other perforation patterns can be used.

In addition, the perforations 20 that are present on each section or location of the perforated chamber can all be the same size and/or shape, or can be different for certain sections or locations. For example, the perforations on the side walls can be different in size compared to the perforations on the back section. In addition, each section can itself include perforations of different sizes. For instance, the perforations at the upstream region of the side walls of the perforated chamber can be different in size compared to the perforations at the downstream region of the side walls. The perforations can be evenly distributed over each section or can have different distributions for different sections and/or within each section. The pattern of the perforations can also take many forms, such staggered or straight, and the shape of the perforations is preferably circular in cross-section but can also be square, hexagonal or another shape. In one example, the side walls of the perforated chamber have smaller perforations (e.g., 20 mm to 30 mm) compared to perforations in the backing plate and/or plunger head (e.g., 25 mm to 40 mm).

Larger perforations can also lead to wet fractions that have higher viscosity materials to flow, such that downstream unit operations can be adapted accordingly. In addition, the press extractor can be mechanically modified to facilitate the use of larger perforations, e.g., stronger and/or thicker materials for the perforated sections and/or greater spacing between the perforations, compared to conventional machines.

Larger perforations also facilitate the use of lower pressures, which can in turn reduce energy use, construction constraints, and processing time. For example, whereas some prior documents have disclosed pressures of up to 300 bars, it was found that 160 bar is acceptable for most MSW while 80-100 bar is acceptable for most SSO with the larger perforation size.

### Process Implementations

The press extractor can be operated in various ways, some of which will be described below. One method of operation is to include the plug thickness (PT) as a process control parameter that is detected and used to control aspects of the pressing operation.

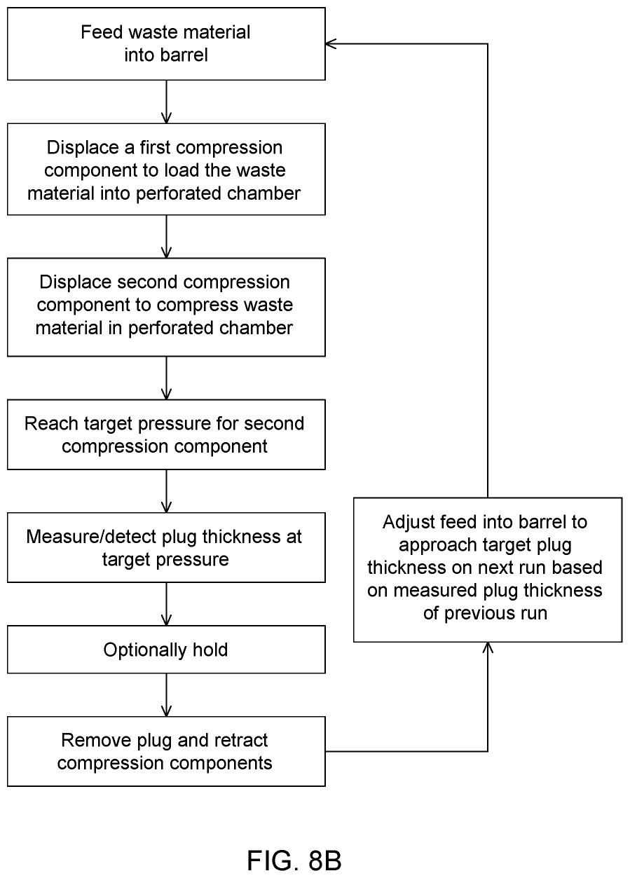

Referring now to FIGS. 7A, 8A and 9A, the press extraction operation can be conducted based on a target plug thickness (PT). Thus, instead of controlling the press extractor based solely on variables such as maximum pressing pressure, the press extractor can be controlled at least in part based on a target PT. The target PT can be predetermined based on experiments, calculations, and/or calibration work, which can take into consideration factors such as the composition of the waste material, downstream processing operations for the wet fraction and the dry plug fraction, target yields and throughput, and the like.

Referring to FIG. 7A, the extraction process can include the following steps: feeding the waste material into the barrel of the press extractor; displacing the plunger within the barrel to compress the material; detecting or otherwise monitoring the PT of the material so that the target PT is reached; once the target PT is reached, optionally holding the plunger in that position; and then removing the plug and retracting the plunger, which can be done in various orders depending on the configuration and operation of the press extractor. For example, the plunger can first be used to push the plug out of the opened chamber, and only after the plug is removed the plunger is retracted. It is also noted that the process of FIG. 7A aligns generally with the press extractor having a single barrel and plunger, such as the one illustrated in FIGS. 1A to 1D.

Referring now to FIG. 8A, the extraction process can include the following steps: feeding the waste material into a loading barrel of the press extractor; displacing a first plunger within the barrel to move the material to a perforated chamber; displacing a second plunger within a second barrel to compress the material in the perforated chamber; reaching the target PT of the material which can include detecting and monitoring PT; once the target PT is reached, optionally holding the plunger in that position; and then removing the plug and retracting the plungers, which can be done in various orders depending on the configuration and operation of the dual plunger press extractor. For example, the second plunger can first be used to push the plug out of the opened chamber, and only after the plug is removed the plungers are retracted. It is also noted that the process of FIG. 7A aligns generally with the press extractor shown in FIGS. 6A to 6D.

Turning now to FIG. 9A, the extraction process can be operated with an optional double-press feature, which can be useful for waste material with higher compositional variability. This example extraction process can include the following steps: feeding the waste material into a loading barrel of the press extractor; and displacing the plunger within the barrel to move the material to a perforated chamber and compress the material. Note that this process can apply to single-plunger or double-plunger press extractors, but only the single-plunger type will be referred to in detail here. If the target PT of the material is reached within certain pressing pressure parameters, such as at a pressing pressure that is above a minimum pressure threshold, then the process can proceed in a similar manner as discussed above with respect to FIGS. 7A and 8A. However, if the target PT of the material is reached but not at the desired pressing pressure parameters, then the process can include retracting the plunger, providing a top-up load of the waster material into the barrel, and then repressing such that both the top-up load and the initially compressed load are compressed together to form the plug. Again, if the target PT of the material is reached with the pressure parameters, the process can proceed as with the other scenarios. In this manner, it is possible to control the process so that periodic loads of waste material having an unusually high concentration of wet material can be processed efficiently without significant reductions in the yield.

Regarding the minimum pressure threshold and multiple cycles, the trigger for performing a second cycle can be if the extractor does not meet the setpoint pressure before arriving within a predetermined end position, which can be for example 30 mm from the door or another predetermined distance that is smaller than the target PT. If the loads have a very high extrudable organics content (e.g., high concentration of fruits or vegetables), the extractor could continue through several cycles without opening the end door as nearly all of the pulp and liquid would pass through the perforations and it is only after adding some solid rejects (e.g., bags, metal, wood, packaging) that the plug would form and need squeezing to the predetermined PT.

Turning now to FIGS. 7B, 8B and 9B, the press extractor can be operated such that, for each run, the plunger movement for compression of the material is controlled based on pressure to achieve a target plunger pressure, the plunger is then stopped, the PT is measured or otherwise determined at that position, and then the determined PT for that run is used to adjust the amount of waste material that is fed into the press extractor for the subsequent run in order to approach a target PT on the subsequent run. Thus, a target PT is used for process control, but not as a directly controlled independent variable. Here, the plunger pressure is controlled directly, and the PT is measured for each run and used to adjust the feed quantity per run. The target pressure can be determined for a given composition of feed material, and can also be adjusted over time depending on various factors such as feed composition. The feed quantity can be adjusted in various ways, such as based on weight, volume and/or plunger pull-back. After each run, the determined PT can be compared to the target PT to obtain a PT difference, and the feed quantity can be adjusted based on the PT difference in accordance with a predetermined relationship and/or with observations of operating the extractor. FIGS. 7B and 8B respectively show example process diagrams for operating a one-plunger extractor and a two-plunger extractor. FIG. 9B shows a process diagram for operating an extractor with an optional double-press feature, where a subsequent press is performed if the plunger does not reach the target pressure before reaching a minimum distance from the back wall.

It should be noted that the precision of the control schemes illustrated in FIGS. 7B, 8B and 9B may depend on the heterogeneity and variability of the waste material feedstock. For highly consistent feedstocks, the control scheme can enable the actual plug thickness to approach closely to the target plug thickness after only a few runs. For feedstocks having more variability, the actual plug thickness for any given run can vary compared to the target plug thickness by 15% or 20% or more, for example. In this regard, for variable feedstocks it may be advantageous to include additional measurements and control of the feedstock to adjust the feed quantity based on the measured and target plug thicknesses as well as data regarding the mass, volume and/or composition of the incoming load.

In addition, referring to FIG. 8B, it is noted that the press extractor can be configured so that compression components other than plungers can be used to compress the material. The use of other types of compression components can apply to the process described in FIG. 8B as well as other processes described or illustrated herein.

In some implementations, the PT can be considered as the thickness of the plug pursuant to the final compression by the plunger 10 or another compression component. Thus, when multiple plungers or compression components are used in certain press extractor designs, as shown in FIGS. 6 and 10, it is the final compression that defines the plug thickness.

The plug thickness can be between about 5% and 20%, or between 10% and 15%, of the infeed material thickness within the barrel prior to compression, for example. For MSW feed material, the density of the feed can be between 200 and 500 kg/m³, while for SSO feed material the density can be between 400 and 700 kg/m³, for example. The pressure exerted on the waste material in the perforated chamber can be above 80 bar or 100 bar for SSO, and above 160 bar for MSW, for example. More particularly, for press extractors with one-directional axial compression, the PT_{AX} could be between 5% and 12% of the infeed material thickness within the barrel prior to compression; while for press extractors with two-directional compression the PT_{AX} could be between 10% and 20% of the infeed material thickness within the barrel prior to final compression along the second direction. In addition, the target PT can be between 40 mm and 250 mm depending on the extractor design. For example, for press extractors with one-directional axial compression, the target PT can be between 40 mm and 120 mm, between 50 mm and 100 mm, or between 60 mm and 80 mm; while for press extractors with two-directional compression, the target PT can be between 100 mm and 250 mm or between 150 mm and 200 mm.

The target plug thickness (PT) can be set depending on certain extractor design and operating features. For example, for a given extractor, the target PT can depend on whether or not the plunger head is perforated. When the plunger head is perforated, the target PT is larger compared to when it is not perforated, based on a same target yield of wet fraction for a given run, as a larger load of material can be pressed when the plunger head is perforated. More generally, the more the area of the perforated chamber that includes perforations, the larger the PT can be for a same yield.

### Waste Material Implementations

In terms of waste materials that can be processed using techniques described herein, the waste material can be MSW or SSO or a combination or fractions thereof. The waste material can be other materials that include organic waste, such as ICI-food waste or non-SSO agricultural waste. In some implementations, the waste material includes putrescible organics and undesirable solid materials, such as plastics, metal, glass, mineral solids such as stones, and the like. The press extractor can be operated to maximize the yield of the putrescible organics in the wet fraction and the overall throughput, while minimizing the concentration of undesirable materials that are entrained in the wet fraction.

In alternative implementations, the waste material can be various pre-consumer food waste or certain industrial waste streams, such as pulp-and-paper streams that include solid and liquid components. For pulp-and-paper applications, the wet fraction can be separated from pulp as part of a dewatering process using the press extractor.

It is also noted that other multiphase materials that include liquid that is shear thinning and flows under pressure and some solids, can be processed using techniques described herein. The multiphase material can be a waste material or a material that is processed to separate fractions thereof. The multiphase material can include extrudable solids that pass through the perforations with the liquid, and/or can include solids that are oversized and do not pass through the perforations. After the separation, the wet fraction and/or the liquid-depleted fraction can be further processed to recover valuable components.

### Control and Operation of Press Extractors

In some implementations, the press extraction can be operated to achieve various benefits, including enhanced organics extraction efficiency using larger perforation sizes, e.g., over 20 mm in diameter; enhanced organics extraction efficiency using plug thickness of 60-80 mm for one-directional press extractor; and enhanced ability to send organics contaminants such as paper and diapers to the organics wet fraction, thereby reducing or avoiding the need for extra cellulose recovery steps from the dry fraction (e.g., pulper after press).

In addition, certain parameters can be adjusted depending on the input characteristics (e.g., MSW vs SSO), such as modifying the control of the axial movement of the plunger to change the target PT based on the feed material. It is also possible to modify parameters, such as target PT, based on the quantity of feed material per load, such that a greater load would result in a greater target PT for that particular cycle.

Therefore, the control assembly can be configured to modify certain setpoints and operating parameters per load, or per a given run time for a given batch of feed material. When operating on a per-load basis, the quantity (e.g., mass and/or volume) of each load can be determined and/or the type of each load (e.g., MSW or SSO) can be determined, and then the target PT for that cycle can be set accordingly along with other parameters like minimum pressure threshold, among others. Alternatively, the target plunger pressure can be obtained for each run and the actual PT can be measured and used with a target PT to control the feed quantity for subsequent runs. The target PT can be established or determined based on predetermined calibration work that relates PT to feed material variables as well as performance parameters like organics yield. Thus, each load can be processed more optimally based at least in part on target PTs. Alternatively, the control method can be generally set for a given run time that includes multiple compression cycles, such that a set PT is predetermined based on the type of material being processed and the target load quantities fed into the extractor. While this method may be less precise than the per-load control method, it can be relatively simple while maintaining advantageous performance.

More particularly, the control assembly can include various components and instrumentation which can be installed and calibrated for the given control process to be implemented. In one example, an operator can control the plunger to stop at a predetermined location (e.g., distance from end door or certain location indicated on the barrel). In another example, the control assembly can be preprogrammed so that the plunger stops at a predetermined distance from the end door. The distance from the end door can be determined in various ways using position sensors. The control method can thus achieve and control defined plug thicknesses for operation of the extractor. In some implementations, position sensor instruments that measure the position of the plunger can be calibrated relative to the alternate face of the chamber, where zero point is the position where the plunger head face touches the opposing back face of the chamber. The control assembly can include a programmable logic controller (PLC) or other programmable controller utilizing the signal (e.g., analogue) from the position sensor to monitor the speed, acceleration, and end position of the plunger. Meanwhile, pressure can be monitored on the hydraulic power system driving the plunger with analog pressure transmitters and sensors. If the hydraulic cylinder coupled to the plunger has a different area compared to the surface area of the plunger, a scaling factor can be used. For control methods that utilize target pressures, as in FIGS. 7B, 8B and 9B, the system can be calibrated and controlled based on the plunger pressure or the hydraulic cylinder pressure or both, for example.

Of course, the control assembly can be configured to monitor and control various other aspects of the extractor, such as the pressure and duration of maximal holding pressure without plunger movement, speed of plunger movement, timing for feeding waste material into the extractor, opening and closing of the backing plate and removal of the plug, among other variables. In addition, other parameters of the extraction process can be monitored and correlated to PT to aid in process control. For example, the volume of the wet fraction removed per run can be correlated to the PT, and the maximum pressure can be correlated to PT particularly when the feedstock water material is well known and characterized.

### RESULTS & EXPERIMENTATION

In experimental runs, effects of plug thickness and perforation size were assessed for one-directional and two-directional press extractors. It was found that increasing the perforation size from a more conventional diameter of about 4 to 8 mm to a size of 26 mm to 30 mm reduced the quantity of organics remaining in the liquid-depleted fraction as more material is pressed through the larger holes, but also the amount of paper and cellulosic-plastic components (e.g., diapers) in the wet fraction increased notably while the amount of plastics in the wet fraction did not increase significantly. Since it can be desirable that the wet fraction include cellulosic organic material, such as paper and diapers, while minimizing other materials, such as plastics, the increase in perforation size was able to have a dual advantage of increasing liquid organics yield as well as solid cellulosic organics yield while not significantly increasing unwanted contaminants (e.g., plastic, stones, metal, glass) in the wet fraction.

Larger perforation size can also facilitate reduced blockage of perforations, reduced wear caused by having unnecessarily high internal pressures or small plug thickness when using smaller perforations; reduced processing of reject fraction to remove organics such as paper; reduced downtime that can occur at high pressures as larger perforations and certain plug thickness can facilitate the use of lower pressures.

Experiments that assessed a 200 ton/day press extractor showed that with smaller perforations of 13 mm there were difficulties recovering desirable yields of paper, organics and pulp from diapers. A new set of perforations with 26 mm diameter were installed and it was found that there was a considerable reduction in the organics in reject fraction and more paper in the wet fraction. For extrusion of certain organics, such as paper and diapers and yard waste, larger holes can provide notable performance enhancements. The following Table 1 summarizes effects of increased perforation size on the wet and liquid-depleted fractions:

TABLE 1

| | | | Fraction | | | |
|---|---|---|---|---|---|---|
| | | | Wet (dry basis) | | Liquid-depleted (wet basis) | |
| Testing | | | 26 mm | 13 mm | 26 mm | 13 mm |
| Parameter | | Units | perforations | perforations | perforations | perforations |
| Total Solids | | % | 27.8% | 28.4% | 57.9% | 54.7% |
| Organics | | % | 58% | 88.3% | 15.6% | 37.8% |
| Bones | | % | 4.7% | | 8.0% | |
| Contaminant | Plastic | % | 6.0% | 4.74% | 41.5% | 30.0% |
| Material | Paper | % | 11.5% | 1.3% | 6.6% | 13.2% |
| | Glass | % | 1.2% | | 0.8% | 0.3% |
| | Metal | % | 0.0% | | 3.2% | 0.2% |
| | Stones | % | 2.9% | 1.0% | 3.1% | |
| | cellulosic- | % | 13.0% | 3.6% | 15.1% | 17.4% |
| | plastic | | | | | |
| | components | | | | | |
| | Other non- | % | | | 0.1% | |
| | processible | | | | | |
| | Yard Waste | % | 2.7% | 1.1% | 6.0% | 1.2% |

| | | | |
|---|---|---|---|
| Average Plug | mm | 30 | 97 |
| Thickness | | | |

As shown in Table 1, the TS of the wet fraction stayed relatively unchanged, while the reject TS rose slightly. There was a large decrease in organic content of the rejects, which is positive. In addition, the 37.8% organic content in the reject fraction with the smaller perforations is likely on the lower side compared to typical operations as well, as 49 wt % organics in the rejects have also been observed. The wet fraction shows the following changes: (a) plastics increased by 25% (4.74% to 6% mass yield), (b), paper in the wet fraction increased by 800%, (c) stones increased by 200%, (d) diapers increased by 250%, and (e) yard waste increased by 150%.

In addition, the average plug thickness decreased from 97 mm to 30 mm. Assuming the same plug density as the previous samples, this would decrease the reject yield from the initially measured 19.9% down to 6.15%.

Plug thickness had not been previously studied, as work focused instead on pressure and perforation size. Results have shown that for a given load of waste material, there can be an advantageous window of plug thickness that allows enhancing organics recovery as well as capacity. For instance, with an example one-directional press extractor, optimal plug thickness was 30-150 mm, preferably 60-80 mm. This was found through experimentation. Larger plug thicknesses with all other variables staying constant resulted in wetter reject fractions, especially in the middle portion of the plug, where organics and moisture appeared to be trapped. As observed from experimentation, the relationship defined an inverse hockey stick shape (blade at top left, stick going down), with an initial relatively constant yield with increasing plug thickness followed by a notable decrease in yield with an increase in plug thickness. It appears that a target plug thickness can be determined as the largest PT that achieves the relatively constant high organics yield, as decreasing the PT would result in minimal organics yield increase and increasing the PT would result in a sharper drop-off of organics yield.

The following Table 2 summarizes findings regarding examples of enhanced plug thicknesses for different press extractors:

TABLE 2

| | | | Ratio of | | |
|---|---|---|---|---|---|
| | | | length | | |
| | | | pre- | | |
| | | | compression | | |
| | | | and | | |
| | | | post- | Range of | |
| | Starting | Enhanced | compression | Enhanced | |
| | Chamber | Plug | at | Plug | |
| | Length | Thickness | Enhanced | Thickness | Extrusion |
| | (mm) | (mm) | PT | (mm) | Direction |
| Extractor | 1100 | 90 | 8% | 40-120 | 1- |
| A | | | | | Directional |
| Extractor | 1200 | 90 | 8% | 40-120 | 1- |
| B | | | | | Directional |
| Extractor | 1000 | 180 | 18% | 100-250 | 2- |
| C | | | | | Directional |

It was noted that the enhanced PT can be in the approximate range of 5% to 15% or 8% to 12%, compared to the axial length of the perforated chamber where the plug is formed, for one-directional press extractors; with a range of 10% to 25% or 15% to 20% for the two-directional press extractor.

Factors that can have an impact on the PT include (i) the location, number and size of perforations of the perforated chamber, (ii) the feed quantity, (iii) the plunger pressure, and (iv) composition and properties of the waste material. For example, when larger perforations are provided, the wet fraction yield can be increased such that the PT would be lower if all other parameters are kept constant; likewise, when larger perforations are provided, the target PT can be higher for the same wet fraction yield as more feed material can be provided per run. When more sides of the chamber are provided with perforations, the wet fraction yield can be increased and the impact on PT and target PT are similar as described above. Thus, the range of PT between 40 mm and 120 mm for Extractor A is given in Table 2 based on variations that may be made to factors (i) to (iv), for example.

Other parameters, such as change in ram position, internal pressure as a function of time, and hold time at maximal pressure have been studied. It has been observed that maintaining the maximal pressure for an additional 3 seconds can lead to 5% increase in organics recovery. Extrusion pressures have also been studied using a pilot press and the pressure at which extraction yield plateaus have been identified for different kinds of feedstock.

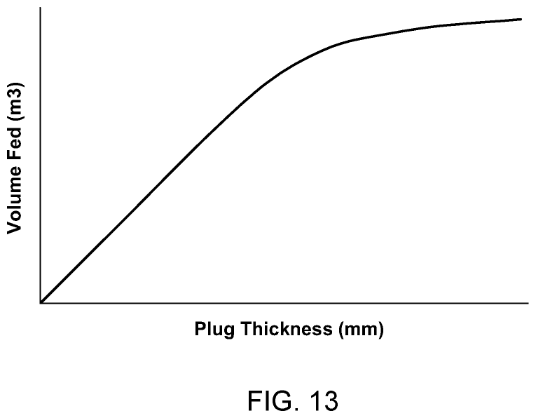

It has also been found that it can be advantageous to feed smaller loads while pressing more quickly and with better efficiency, for instance based on a predetermined plug thickness. Smaller loads in this context can correspond to reduced load sizes for which the response of plug thickness is linear. FIG. 13 shows that for load sizes to the right of the inflection point there are organics lost in the plug, whereas to the left of the inflection point substantially all of the organics present in the load are extruded out. The size of the load to be used can be determined by performing tests that identify the linear region and operating the extractor accordingly.

The following Table 3 shows a comparison between an extractor with standard perforation sizing compared to an extractor with enlarged perforation sizing, in terms of impacts on output stream compositions.

TABLE 3

| | | Wet Fraction (Recovered Organics) | | | | Dry Fraction | |
|---|---|---|---|---|---|---|---|
| | | Standard | Per | Enlarged | Per | Standard | Enlarged |
| | Raw | perforation | 100 | perforation | 100 | perforation | perforation |
| | Waste | sizing (50%) | ton | sizing (75%) | ton | sizing | sizing |
| Plastics | 25% | 4% | 2 | 8% | 6 | 46% | 76% |
| Paper | 20% | 15% | 7.5 | 25% | 18.75 | 25% | 5% |
| Yard | 5% | 3% | 1.5 | 5% | 3.75 | 7% | 5% |
| Waste | | | | | | | |
| Food | 40% | 70% | 35 | 50% | 37.5 | 10% | 10% |
| Waste | | | | | | | |
| Organics | | | | | | | |
| Glass | 10% | 8% | 4 | 12% | 9 | 12% | 4% |
| and | | | | | | | |
| inerts | | | | | | | |

Effects of perforation size on the composition of the output streams of the press extractor can be framed in various ways. For example, the large perforations can facilitate one or more of the following:
(i) A wet fraction that has an increased amount of cellulosic materials, such as paper and/or cellulose-plastic components. For example, the wet fraction can have at least 10 wt %, 15 wt %, or 20 wt % paper or can have a paper percentage greater than the paper percentage of the waste material. The wet fraction can be at least 5 wt %, 10 wt % or 15 wt % of cellulose-plastic components (e.g., diapers or other items that have both cellulosic and plastic parts).
(ii) A wet fraction that has an increased amount of plastics but below an upper threshold, such as 8 wt %, or between 6 wt % and 10 wt %, or a plastics percentage that is at most half of the plastics percentage in the waste material.
(iii) A wet fraction that has an increased yield of organics, such as at least 70%, at least 80% or at least 90% yield.
(iv) A liquid-depleted fraction that has a decreased amount of cellulosic materials, such as paper and/or cellulose-plastic components. The liquid-depleted fraction can have at most 15 wt %, 10 wt %, or 5 wt % paper or can have a paper percentage lower than the paper percentage of the waste material.
(v) A liquid-depleted fraction that has a lower percentage of organics, such as below 20 wt %, below 15 wt %, or below 10 wt %.

It is noted that the aspects and implementations of the technology described herein should not be viewed as limiting since variations are also possible.

1. An extraction system for processing waste material to form a wet fraction comprising organics and a liquid-depleted fraction, comprising:
a barrel;
a plunger received within the barrel and configured to displace axially within the barrel;
a perforated chamber having perforations and being connected to a distal end of the barrel, the perforated chamber being configured to receive a load of waste material and a head of the plunger during axial displacement into the perforated chamber to compress the load of waste material to cause wet material to be expelled out of the perforated chamber through the perforations and form the wet fraction, the perforations being sized and configured to have a diameter between 20 mm and 40 mm and to provide a total open area between 10% and 40%.

2. The system of claim 1, wherein the barrel comprises a feed inlet for receiving the load of waste material, and is configured such that the plunger displaces the load through the barrel into the perforated chamber.

3. The system of claim 1, wherein the barrel is a primary barrel and the plunger is a primary plunger, and wherein the system further comprises:
a second barrel oriented perpendicularly with respect to the primary barrel and configured to receive the load of waste material, the second barrel being in communication with the perforated chamber; and
a second plunger disposed in the second barrel and configured to displace the load into the perforated chamber prior to the primary barrel compressing the load within the perforated chamber.

4. The system of claim 1, further comprising a pre-press assembly that is configured to radially compress the load of waste material and to form part of the barrel prior to axial displacement of the plunger to compress the load in the perforated chamber.

5. The system of claim 1, wherein the plunger and the perforated chamber are configured to compress the load axially to form a plug that forms part of the liquid-depleted fraction.

6. The system of claim 1, wherein the plunger and the perforated chamber are configured to compress the load radially to form a tubular plug that forms part of the liquid-depleted fraction.

7. The system of claim 1, wherein the diameter of the perforations is above 22 mm, 24 mm, 26 mm, 28 mm or 30 mm.

8. (canceled)

9. The system of m claim 1, wherein the total open area provided by the perforations is above 12%, 14%, 16%, 18% or 20%.

10. (canceled)

11. (canceled)

12. The system of claim 1, wherein the perforated chamber includes no other openings for passage of the wet material that are smaller than the perforations having the diameter between 20 mm and 40 mm.

13. The system of claim 1, wherein the perforated chamber is defined by perforated side walls, a backing plate, and the head of the plunger, and wherein the backing plate and/or the head of the plunger are also perforated.

14. The system of claim 13, wherein the perforations in the perforated side walls are smaller than the perforations in the backing plate and/or the head of the plunger.

15. (canceled)

16. The system of claim 1, wherein the system is configured to compress the load in the perforated chamber to a target plug thickness.

17.-19. (canceled)

20. The system of claim 16, wherein the target plug thickness is between 60 mm and 80 mm.

21. The system of claim 16, further comprising a control assembly configured to control the system based at least in part on the target plug thickness.

22. The system of claim 21, wherein the control assembly comprises a position sensor for sensing a position of the plunger, and is configured to control axial displacement of the plunger based on the sensed position of the plunger to achieve the target plug thickness within the perforated chamber.

23.-49. (canceled)

50. An extraction system for processing waste material to form a wet fraction comprising organics and a liquid-depleted fraction, comprising:
a barrel;
a plunger received within the barrel and configured to displace axially within the barrel;
a perforated chamber having perforations and being connected to a distal end of the barrel, the perforated chamber being configured to receive a load of waste material and a head of the plunger during axial displacement into the perforated chamber to compress the load of waste material to cause wet material to be expelled out of the perforated chamber through the perforations and form the wet fraction;
wherein the load of the waste material comprises cellulosic materials, organic-rich liquid materials, and non-organic materials; and
wherein the perforations are sized and configured such that at a compression pressure between 60 and 160 bar, the wet fraction and/or liquid-depleted fraction have one or more of the following characteristics:
the wet fraction has at least 10 wt % paper;
the wet fraction has a paper percentage greater than a paper percentage of the waste material;
the wet fraction is composed of at least 5 wt % of cellulose-plastic components;
the wet fraction has a plastic content between 6 wt % and 10 wt % the wet fraction has a plastics percentage that is between a quarter and a half of the plastics percentage in the waste material;
the wet fraction has an organics yield of at least 70%;
the liquid-depleted fraction has at most 15 wt % of the cellulosic materials;
the liquid-depleted fraction has a percentage of the cellulosic materials that is lower than the cellulosic materials percentage of the waste material;
the liquid-depleted fraction has an organics content below 20 wt %.

51.-56. (canceled)

57. An extraction system for processing waste material to form a wet fraction comprising organics and a liquid-depleted fraction, comprising:
a barrel;
a plunger received within the barrel and configured to displace axially within the barrel;
a perforated chamber having perforations and being connected to a distal end of the barrel and configured to receive a load of waste material and to receive a head of the plunger during axial displacement into the perforated chamber to compress the load of waste material to cause wet material to flow out of the perforated chamber through the perforations and form the wet fraction and a liquid-depleted plug; and
a control assembly configured to measure a position of the plunger to determine a measured plug thickness of the liquid-depleted plug, and control compression of the load of the waste material at least in part based on a target plug thickness of the liquid-depleted plug within the perforated chamber.

58. The system of claim 57, wherein the control assembly comprises a position sensor for sensing the position of the plunger, and is configured to control axial displacement of the plunger based on the sensed position of the plunger to achieve the target plug thickness within the perforated chamber.

59. The system of claim 58, wherein the control assembly is further configured to control the axial displacement of the plunger to achieve the target plug thickness when a minimum pressure threshold is achieved at the predetermined plug thickness.

60. The system of claim 59, wherein the minimum pressure threshold is 60 bar when the waste material is source separated organics (SSO), and wherein the minimum pressure threshold is 120 bar when the waste material is municipal solid waste (MSW).

61.-111. (canceled)
